(19) United States
(12) Patent Application Publication
(10) Pub. No.: US 2020/0342460 A1
(43) Pub. Date: Oct. 29, 2020

(54) USER IDENTITY VERIFICATION

(71) Applicant: Alibaba Group Holding Limited, George Town (KY)

(72) Inventor: Yuxing Sun, Hangzhou (CN)

(73) Assignee: Alibaba Group Holding Limited, George Town (KY)

(21) Appl. No.: 16/803,830

(22) Filed: Feb. 27, 2020

Related U.S. Application Data
(63) Continuation of application No. PCT/CN2020/071421, filed on Jan. 10, 2020.

(30) Foreign Application Priority Data
Apr. 24, 2019 (CN) 201910333835.1

(51) Int. Cl. G06Q 20/40; G06Q 20/38; G06Q 20/10

(52) U.S. Cl. CPC G06Q 20/4018; G06Q 20/102; G06Q 20/3827; G06Q 20/409

(57) ABSTRACT

A computer-implemented identity verification method includes: receiving, by a payment platform, a verification request including a request to verify a user identity associated with a bank card; generating a first code string; storing the first code string in association with a user identifier and with a card identifier of the bank card; sending a deduction request to a card issuer of the bank card, in which the deduction request includes a request to deduct a first amount from an account associated with the bank card, and in which the deduction request includes the first code string; receiving a second code string; verifying that the second code string is consistent with a corresponding part of the first code string; and based on verifying that the second code string is consistent with the corresponding part of the first code string, verifying the user identity associated with the bank card.

### CROSS-REFERENCE TO RELATED APPLICATIONS

This application is a continuation of PCT Application No. PCT/CN2020/071421, filed on Jan. 10, 2020, which claims priority to Chinese Patent Application No. 201910333835.1, filed on Apr. 24, 2019, and each application is hereby incorporated by reference in its entirety.

### TECHNICAL FIELD

One or more implementations of the present specification relate to the field of electronic payment security, and in particular, to payment identity verification methods and devices.

### BACKGROUND

In electronic payment scenarios, payment security is most concerned by users, and is also a very important technical issue faced by electronic payment platforms. To ensure payment security, security inspection is performed on payment requests, especially for payments made with credit cards. Interception is performed when it is determined that there is a risk of the payment, so as to prevent card stealing, fraudulent card use, getting cash from a credit card, etc. When the previous payment interception cases occur, a user can apply for identity verification, and when identity verification succeeds, the user can continue to use the credit card for payment.

### SUMMARY

One or more implementations of the present specification describe user payment identity verification methods and devices, where a bank bill is used to notify a user of a verification code used for verification, thereby more efficiently implementing payment identity verification.

According to a first aspect, a payment identity verification method is provided, and is performed by a payment platform, and includes: sending a first request message to a security platform in response to a verification request of a first user, where the verification request is used to request to verify a card owner identity of the first user for a first bank card, and the first request message includes a user identifier of the first user and a card identifier of the first bank card; receiving, from the security platform, a first code string generated for the first request message; and sending a deduction request to a card issuer of the first bank card, where the deduction request is used to request to deduct a first amount from an account of the first bank card, and the deduction request includes the first code string, where the card issuer includes the first code string in a bill for the first bank card.

In an implementation, the first amount is an amount corresponding to a minimum payment unit of a settlement currency.

In an implementation, the deduction request includes a transaction-related product information field, and the product information field includes the first code string.

In another implementation, the deduction request includes a note information field, and the note information field includes the first code string.

In an implementation, before the sending a first request message to a security platform in response to a verification request of a first user, the method further includes: receiving a first payment request requesting that the first user uses the first bank card to make payment; sending a first notification to the first user indicating that the first payment request is rejected or suspended, where the first notification includes entry information that points to an identity verification page; and receiving the verification request of the first user, where the verification request is sent by the first user by performing a predetermined operation on the identity verification page by using the entry information.

In an implementation, after the sending a deduction request to a card issuer of the first bank card, the method further includes: receiving a second code string entered by the first user and used to verify the card owner identity of the first user for the first bank card; sending a second request message to the security platform, where the second request message includes the user identifier of the first user, the card identifier of the first bank card, and the second code string; receiving a verification result from the security platform, where the verification result indicates whether the second code string is consistent with a corresponding part of the first code string stored in the security platform; and determining an identity verification result of the first user for the first bank card based on the verification result.

Specifically, in an implementation, when the verification result is “consistent”, it is determined that the identity verification result is a verification success. After this, a second notification that the verification succeeds is sent to the first user.

According to an implementation, before the sending a first request message to a security platform, the method further includes: receiving a first payment request requesting that the first user uses the first bank card to make payment; sending a first notification to the first user indicating that the first payment request is suspended in an implementation under such situation, after it is determined that the identity verification result is a verification success, the first payment request can continue to be processed; and the second notification includes notification content that the first payment request is processed.

According to a second aspect, a payment identity verification method is provided, and is performed by a security platform, and includes: receiving a first request message from a payment platform, where the first request message includes a user identifier of a first user and a card identifier of a first bank card; generating a first code string for the first request message; storing the first code string in association with the user identifier of the first user and the card identifier of the first bank card; and sending the first code string to the payment platform, where the payment platform sends a deduction request to a card issuer of the first bank card based on the first code string, where a bill of the first bank card includes the first code string.

In an implementation, a character string with a predetermined length is randomly generated as the first code string.

In another implementation, a first character string is formed by using the user identifier of the first user, the card identifier of the first bank card, and a current time; and a hash operation is performed on the first character string to obtain the first code string.

According to an implementation, the method in the second aspect further includes: receiving a second request message from the payment platform, where the second request message includes the user identifier of the first user, the card identifier of the first bank card, and a second code string entered by the first user; obtaining, based on the user identifier of the first user and the card identifier of the first bank card, the first code string stored in association with the user identifier of the first user and the card identifier of the first bank card; verifying whether the second code string is consistent with a corresponding part of the first code string; and sending a verification result to the payment platform, where the payment platform determines an identity verification result of the first user for the first bank card based on the verification result.

In a specific implementation, verifying whether the second code string is consistent with a corresponding part of the first code string can include: comparing the second code string with a predetermined part of the first code string.

According to a third aspect, a payment identity verification method is provided, and is performed by a payment platform, and includes: receiving a verification request of a first user, where the verification request is used to request to verify a card owner identity of the first user for a first bank card; generating a first code string for a user identifier of the first user and a card identifier of the first bank card, and storing the first code string in association with the user identifier of the first user and the card identifier of the first bank card; and sending a deduction request to a card issuer of the first bank card, where the deduction request is used to request to deduct a first amount from an account of the first bank card, and the deduction request includes the first code string, where the card issuer includes the first code string in a bill for the first bank card.

In an implementation, the method further includes: receiving a second code string entered by the first user and used to verify the card owner identity of the first user for the first bank card; obtaining, based on the user identifier of the first user and the card identifier of the first bank card, the first code string stored in association with the user identifier of the first user and the card identifier of the first bank card; verifying whether the second code string is consistent with a corresponding part of the first code string; and determining an identity verification result of the first user for the first bank card based on the verification result.

According to a fourth aspect, a payment identity verification device is provided, deployed on a payment platform, and includes: a first request sending unit, configured to send a first request message to a security platform in response to a verification request of a first user, where the verification request is used to request to verify a card owner identity of the first user for a first bank card, and the first request message includes a user identifier of the first user and a card identifier of the first bank card; a first code string receiving unit, configured to receive, from the security platform, a first code string generated for the first request message; and a deduction request sending unit, configured to send a deduction request to a card issuer of the first bank card, where the deduction request is used to request to deduct a first amount from an account of the first bank card, and the deduction request includes the first code string, where the card issuer includes the first code string in a bill for the first bank card.

In an implementation, the device further includes: a second code string receiving unit, configured to receive a second code string entered by the first user and used to verify the card owner identity of the first user for the first bank card; a second request sending unit, configured to send a second request message to the security platform, where the second request message includes the user identifier of the first user, the card identifier of the first bank card, and the second code string; a verification result receiving unit, configured to receive a verification result from the security platform, where the verification result indicates whether the second code string is consistent with a corresponding part of the first code string stored in the security platform; and a verification result determining unit, configured to determine an identity verification result of the first user for the first bank card based on the verification result.

According to a fifth aspect, a payment identity verification device is provided, deployed on a security platform, and includes: a first request receiving unit, configured to receive a first request message from a payment platform, where the first request message includes a user identifier of a first user and a card identifier of a first bank card; a code string generation unit, configured to generate a first code string for the first request message; a code string storage unit, configured to store the first code string in association with the user identifier of the first user and the card identifier of the first bank card; and a code string sending unit, configured to send the first code string to the payment platform, so the payment platform sends a deduction request to a card issuer of the first bank card based on the first code string, so as to include the first code string in a bill of the first bank card.

In an implementation, the device further includes: a second request receiving unit, configured to receive a second request message from the payment platform, where the second request message includes the user identifier of the first user, the card identifier of the first bank card, and a second code string entered by the first user; a code string acquisition unit, configured to acquire, based on the user identifier of the first user and the card identifier of the first bank card, the first code string stored in association with the user identifier of the first user and the card identifier of the first bank card; a code string verification unit, configured to verify whether the second code string is consistent with a corresponding part of the first code string; and a verification result sending unit, configured to send a verification result to the payment platform, where the payment platform determines an identity verification result of the first user for the first bank card based on the verification result.

According to a sixth aspect, a payment identity verification device is provided, deployed on a payment platform, and includes: a verification request receiving unit, configured to receive a verification request of a first user, where the verification request is used to request to verify a card owner identity of the first user for a first bank card; a first code string generation unit, configured to generate a first code string for a user identifier of the first user and a card identifier of the first bank card, and store the first code string in association with the user identifier of the first user and the card identifier of the first bank card; and a deduction request sending unit, configured to send a deduction request to a card issuer of the first bank card, where the deduction request is used to request to deduct a first amount from an account of the first bank card, and the deduction request includes the first code string, where the card issuer includes the first code string in a bill for the first bank card.

In an implementation, the device further includes: a second code string receiving unit, configured to receive a second code string entered by the first user and used to verify the card owner identity of the first user for the first bank card; a first code string acquisition unit, configured to acquire, based on the user identifier of the first user and the card identifier of the first bank card, the first code string stored in association with the user identifier of the first user and the card identifier of the first bank card; a code string verification unit, configured to verify whether the second code string is consistent with a corresponding part of the first code string; and a verification result determining unit, configured to determine an identity verification result of the first user for the first bank card based on the verification result.

According to a seventh aspect, a computer readable storage medium that stores a computer program is provided, and when the computer program is executed on a computer, the computer is caused to perform the methods according to the first aspect to the third aspect.

According to an eighth aspect, a computing device is provided and includes a memory and a processor. Executable code is stored in the memory, and when executing the executable code, the processor implements the methods according to the first aspect to the third aspect.

Based on the methods and the devices provided in the implementations of the present specification, the verification code for verifying the payment identity of the user is included in the bank bill, so only a legal card holder can know the verification code by querying the bill, so as to complete identity verification. In the previous process, there is no need for the user to submit a photo or other proof data, and there is no need for manual verification, which saves labor cost and improves payment experience of the user.

### BRIEF DESCRIPTION OF DRAWINGS

To describe the technical solutions in the implementations of the present disclosure more clearly, the following briefly describes the accompanying drawings needed for describing the implementations. Clearly, the accompanying drawings in the following description show merely some implementations of the present disclosure, and a person of ordinary skill in the art can still derive other drawings from these accompanying drawings without creative efforts.

FIG. 1 is a schematic diagram illustrating an implementation scenario of an implementation disclosed in the present specification;

FIG. 2 shows a payment identity verification method, according to an implementation;

FIG. 3 shows a payment identity verification method, according to an implementation;

FIG. 4 is a schematic block diagram illustrating a payment identity verification device, according to an implementation;

FIG. 5 is a schematic block diagram illustrating a payment identity verification device, according to an implementation;

FIG. 6 is a schematic block diagram illustrating a payment identity verification device, according to an implementation.

### DESCRIPTION OF IMPLEMENTATIONS

The following describes the solutions provided in the present specification with reference to the accompanying drawings.

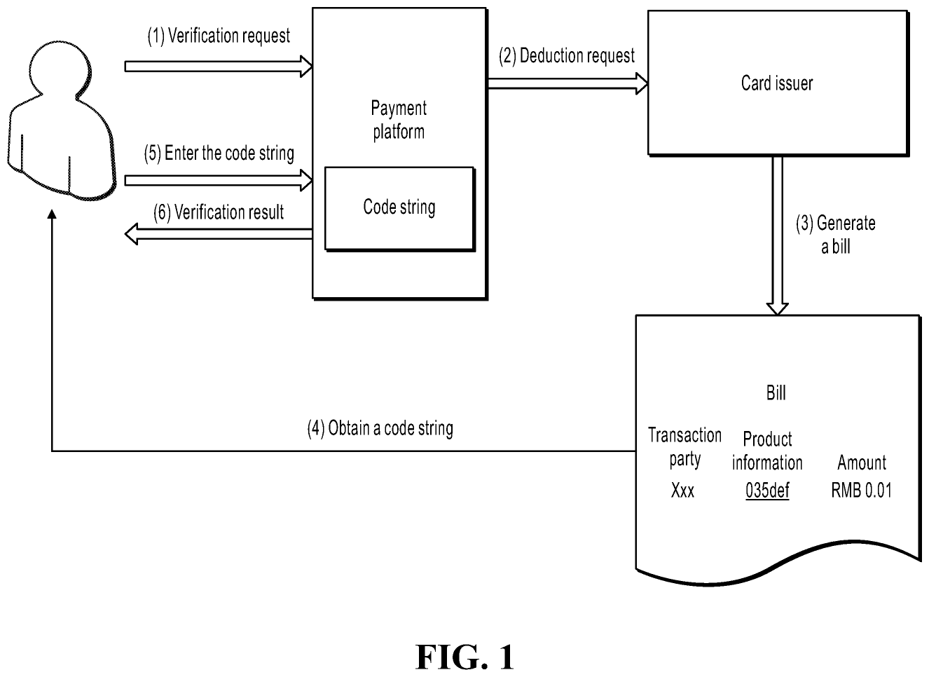

FIG. 1 is a schematic diagram illustrating an implementation scenario of an implementation disclosed in the present specification. According to the implementation of FIG. 1, when a payment identity of a certain bank card needs to be verified, a user can send a verification request to a payment platform. The payment platform generates a dynamic code string by itself or by using a risk control system, includes the dynamic code string in a deduction request, and requests a deduction made by a card issuer of the bank card. An amount requested for deduction can be an amount corresponding to a minimum payment unit, for example, one cent. After the card issuer deducts the corresponding amount based on the deduction request, a bill is generated. The bill includes the above code string. As such, the user can obtain a dynamic code string by querying the bank bill. Then, the user can enter the code string queried from the bill into the payment platform. By comparing the code string entered by the user with a code string previously generated by a system, it can be determined whether the user is a card owner, thereby implementing verification on the payment identity of the user.

In the previous process, the user does not need to upload photo data and a staff member does not need to perform manual processing, but the payment identity of the user can be verified effectively and accurately. The following describes specific implementation steps of the previous process.

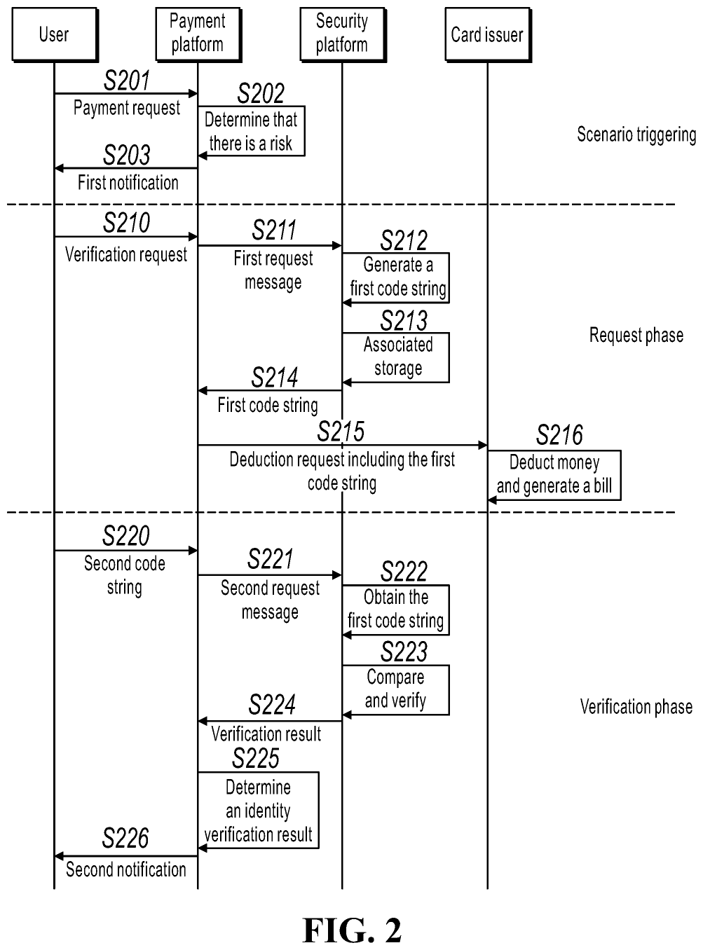

FIG. 2 shows a payment identity verification method, according to an implementation. As shown in FIG. 2, the method can relate to a user, a payment platform, a security platform, and a card issuer.

The payment platform is a platform on which the user makes electronic payment, such as ALIPAY. Generally, the payment platform can provide multiple payment channels for the user to choose, which usually include payment via a bank card. The user can bind one or more bank cards on the payment platform and authorize the payment platform to pay via the bank card. Then, the payment platform can send account operation instructions such as deduction and transfer to the card issuer of the bound bank card based on the authorization of the user.

Generally, the payment platform includes a client and a server. The client is, for example, a mobile phone App or a webpage client, so as to directly interact with the user. The server can receive data of the client for further processing. In the present specification, for simplicity of description, the mentioned operation and processing of the payment platform can be performed by the client or can be performed by the server, which is not differentiated.

The security platform can also be referred to as a risk control system, and is used for access security detection and risk control. In payment scenarios, the security platform can analyze an access user, so as to determine that the user is a normal user or a high-risk user, and can further analyze a payment request of the user, so as to determine whether there is a risk of the payment, for example, whether the payment is suspected of fraud or fraudulent card use.

In the implementation of FIG. 2, payment identity verification is provided for the user by means of interaction among the payment platform, the security platform, and the card issuer. The following describes a process of performing the verification method.

As shown in FIG. 2, the user can send a card owner identity verification request for a certain bank card to the payment platform at step S210. The bank card can be a credit card or a debit card, where identity verification for the credit card is more typical. For ease of description, the following describes the bank card targeted by the user as a first bank card. An identity verification request for the first bank card can be triggered in multiple scenarios.

In an example, in a process that the user binds the first bank card, or after the user binds the first bank card, the payment platform can require the user to perform identity verification on the first bank card, so as to ensure security of subsequent card usage. In such case, the payment platform can, at an appropriate time, jump an operation page of the user to an identity verification page, and the user sends an identity verification request by performing a specific operation on the identity verification page, for example, clicking “request verification”.

In another example, the user can actively enter an identity verification page and request to perform identity verification, so as to improve some usage permission, for example, increase a card limit and increase credit score. In such case, the user can actively enter the identity verification page, and select a bank card to perform a specific operation, so as to send an identity verification request.

In still another example, when being prevented from using a card, the user is prompted to request to perform identity verification. For example, as shown in FIG. 2, before step S210, the method can further include step S201. The user requests the payment platform to use the first bank card for payment, that is, sends a payment request for payment by using the first bank card. In step S202, the payment platform determines that the payment is at risk. There can be multiple determining criteria for determining a payment risk. For example, a payment amount requested is relatively large, and is far higher than average consumption of the bank card within a period of time (for example, recent half a year). For another example, the payment is a cross-border payment and the amount exceeds a certain threshold. Or payment is too frequent in the last one hour, etc. The payment risk can be determined by the payment platform itself, or the payment platform can send related information of the payment request to the security platform, and the security platform determines the payment risk and notifies a result of the determining.

When it is determined that the payment is at risk, the payment platform can reject the payment request or suspend the payment request. Then, in step S203, the payment platform sends a notification to notify the user that the previous first payment request is rejected or suspended. For simplicity of description, the notification is referred to as a first notification. Generally, the payment platform can include entry information that points to the identity verification page in the first notification, and the user can enter the identity verification page by using the entry information, so as to send a verification request.

For example, the previous first notification can be a short message notification, and the notification can include a link. The user is prompted to click the link to enter the identity verification page to start an identity verification procedure, so as to continue to use the bank card. For another example, the previous first notification can be a payment result display page in a client App, and the page can include an option button that points to the identity verification page. The user can click the button to enter the identity verification page.

With the triggering in the previous scenarios, the user can send an identity verification request to the payment platform to start a request stage process.

In response to the identity verification request of the user, the payment platform can obtain a user identifier of the user and card information of the first bank card, which includes a card number and a card issuer. Then, in step S211, the payment platform sends a first request message to the security platform, where the first request message includes the user identifier of the user and a card identifier of the first bank card. The card identifier of the first bank card can be the card number of the bank card. Or for privacy protection, the card identifier can be a predetermined several bits in the card number of the first bank card, or another card ID identifier generated based on the card number.

After receiving the first request message, the security platform dynamically generates a code string, referred to as a first code string, for the request message in step S212.

The security platform can generate the first code string by using various algorithms. In an implementation, the security platform can randomly generate a character string with a predetermined length as the first code string. In another implementation, the security platform can form a character string by using the user identifier of the user and the card identifier of the first bank card, and then perform a hash operation on the character string, where a result of the hash operation is used as the first code string. In still another implementation, the security platform can further add a timestamp, that is, a character string is formed by using the user identifier of the user, the card identifier of the first bank card, and a current time, and then a hash operation is performed on the character string to obtain the first code string.

According to different generation algorithms, a length and a form of the first code string can also be implemented in multiple methods. In an example, the first code string is a 4-digit numerical string or a 6-digit numerical string. In another example, the first code string is a 6-bit character string containing lowercase letters and numbers. In still another example, the first code string is an 8-bit character string containing uppercase letters and numbers. In other examples, the first code string can have other lengths and forms.

After the first code string is generated, in step S213, the security platform stores the generated first code string in association with the user identifier of the user and the card identifier of the first bank card. In addition, in step S214, the security platform sends the first code string to the payment platform.

It is worthwhile to note that steps S213 and S214 can be performed in any sequence, which is not limited here.

Correspondingly, the payment platform receives the generated first code string by using step S214. Then, in step S215, the payment platform sends a deduction request to the card issuer of the first bank card. The deduction request is used to request to deduct a first amount from an account of the first bank card, and the first code string is included in the deduction request, so a bill of the first bank card includes the first code string.

It can be understood that the deduction is only used to generate a bill, so as to include the first code string in the bill. Therefore, the requested deduction amount should be as small as possible, so as to alleviate impact on the user's assets. In an example, the first amount can be an amount corresponding to a minimum payment unit of a local settlement currency, for example, RMB 1 cent. More preferably, the first amount can be an amount corresponding to a minimum payment unit of an international settlement currency, for example, $ one cent, so as to better adapt to international payment situations. Certainly, the first amount can be randomly generated in a relatively small predetermined range but not fixed. For example, an amount between one cent and five cents is randomly selected as the first amount.

To reflect the code string in the bill, the deduction request can include the first code string in different fields. In an implementation, the first code string can be included in a trade-related product information field in the deduction request. In another implementation, the deduction request includes a note information field, and the first code string can be filled in the note information field.

For the deduction request, in step S216, the card issuer deducts the first amount from the account corresponding to the first bank card based on an instruction of the deduction request, and generates a bill, where the bill includes the first code string. Specifically, the first code string is included in different positions of the bill based on a field in which the first code string is in the deduction request.

For example, if the deduction request includes the first code string in a product information field, correspondingly, the generated bill includes the first code string in product information corresponding to a transaction of the first amount. If the deduction request includes the first code string in a note information field, correspondingly, the generated bill includes the first code string in note information corresponding to a transaction of the first amount.

In another example, the card issuer can further include the first code string in another predetermined location of the bill based on an agreement with the payment platform.

If the user is the card owner of the first bank card, that is, a legal card holder, the user has the right to query the bill, so as to know a dynamic code generated for identity verification of the user. Specifically, the user can query the bill by using a corresponding client app of the card issuer, log in to an online bank to query the bill, or query a received e-bill or paper bill. As such, the legal user can obtain, by using bill information, the code string used for identity verification, that is, the first code string.

Then, the user can re-enter the identity verification page to start the verification phase process.

Specifically, in step S220, the user can enter a verification code string into an entry interface reserved on the page based on a page prompt of the identity verification page. In an example, content of the page prompt can include prompting the user to enter the code string (the first code string) at a specific location in the bill information into the entry interface. In another example, the prompt content can be: prompting the user to enter a predetermined part of the first code string in the bill, for example, the last four bits, into the entry interface. For ease of description, a code string entered by the user is referred to as a second code string.

It can be understood that when the user is the legal card holder, the second code string is generally entered by the user by querying the first code string in the bill. In another case, such as a case of card stealing or fraudulent card use, an illegal user may attempt to enter the second code string.

The payment platform receives, by using step S220, the second code string entered by the user. Next, in step S221, the payment platform sends a second request message to the security platform. The step includes: verifying the user identifier of the user and the card identifier of the first bank card, and the second code string entered by the user.

Correspondingly, after the security platform receives the second request message, in step S222, the security platform extracts the user identifier and the card identifier from the second request message, and obtains the first code string that is pre-stored in association with the user identifier and the card identifier.

It can be understood that, in step S213 of the request phase, the security platform has stored the generated first code string in association with the user identifier of the user and the card identifier of the first bank card, thereby forming a data record. For a large number of verification requests of a large number of users, the security platform can store multiple such data records by using a database, and each data record stores one association relationship among a user identifier, a card identifier, and a code string. In step S222, the user identifier and the card identifier of the first bank card included in the second request message can be retrieved in the database as an index, so as to obtain the first code string corresponding to the user identifier and the card identifier of the first bank card.

Next, in step S223, the security platform verifies whether the received second code string is consistent with the stored corresponding part of the first code string.

When the user is required to enter the entire code string in the bill, the second code string is compared with the first code string. In a possible example, only a predetermined part of the code string in the bill is required to be entered by the user, for example, the last four bits. In this case, in step S223, the second code string is compared with the corresponding predetermined part of the first code string. A verification result can be generated through the previous comparison and includes “consistent” and “inconsistent”.

Then, in step S224, the security platform sends the verification result to the payment platform, and correspondingly, the payment platform obtains the verification result. Then, in step S225, the payment platform determines an identity verification result of the user for the first bank card based on the verification result, and in step S226, notifies the user of the identity verification result.

Specifically, when the verification result is “inconsistent”, the payment platform can determine that the payment identity verification result of the user is “failed”. In an example, the payment platform can notify the user of the verification failure. Further, in an implementation, the payment platform can further provide the user with further operation prompts and entry option information, such as re-entering a code string, re-requesting verification, and switching to manual processing.

When the verification result is “consistent”, the payment platform can determine that the payment identity verification result of the user is “succeeded”. In an example, the payment platform can notify the user of the verification success.

As described above, in a possible implementation scenario, the user initiates identity verification when being prevented from using a card. In a specific example, a payment request that the user previously requested to pay by using the first bank card is suspended. In this case, after the payment platform confirms that the identity of the user is verified, the payment platform can continue to process the payment request previously suspended, and prompt the user that the previous payment request is processed. Further, in an example, the payment request is set with a maximum suspension period, for example, 3 days or 7 days. Once the maximum suspension period is exceeded, the payment request is rejected. Correspondingly, after confirming that the user identity is verified, the payment platform further determines whether a time interval between a current time and a request time of the previous payment request exceeds the maximum suspension period, and continues to process the payment request only when the time interval does not exceed the maximum suspension period.

In a specific example, a payment request that the user previously requested to pay by using the first bank card is rejected. In this case, after confirming that the user identifier is verified, the payment platform can send a notification to the user that the user can attempt to send the payment request again.

As such, user payment identity verification is implemented by using the previous implementation. In the implementation of FIG. 2, the payment platform and the security platform are separately disposed, the payment platform interacts with the user and the card issuer, and the security platform is responsible for generating and verifying the verification code, so as to further ensure payment security. In another implementation, the function of the security platform can be integrated into the payment platform, and an identity verification process is implemented by using the payment platform.

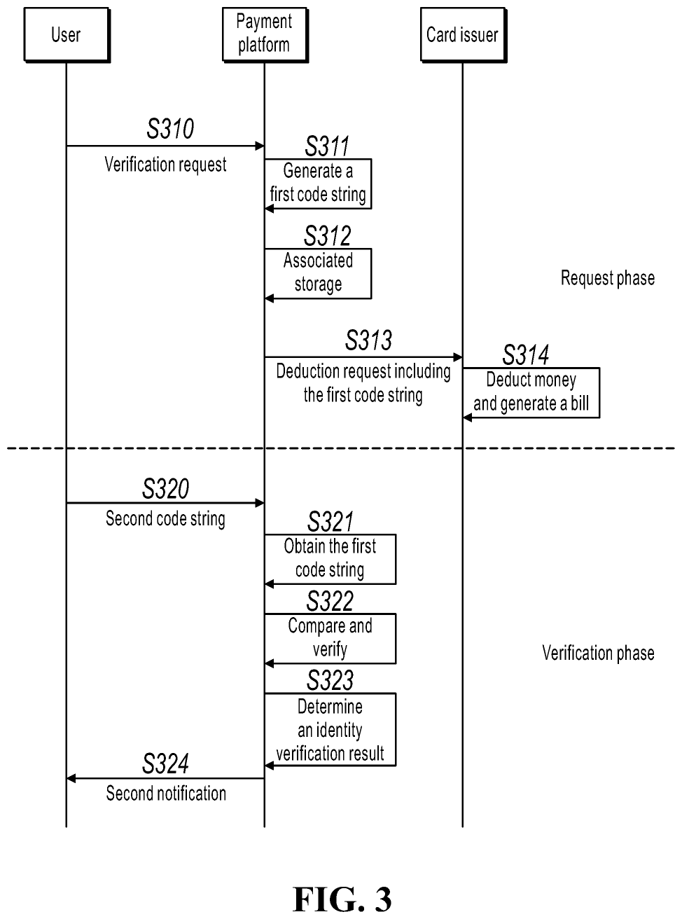

FIG. 3 shows a payment identity verification method, according to an implementation. As shown in FIG. 3, the method can relate to a user, a payment platform, and a card issuer, and it can be understood that the payment platform is integrated with a function of the security platform shown in FIG. 2.

Based on the implementation shown in FIG. 3, the user can send a payment identity verification request for a first bank card to the payment platform in step S310. The user can send the verification request in a card binding process, in response to a notification of the payment platform when the user is prevented from using the card, or can actively send the verification request.

Correspondingly, the payment platform receives the verification request of the user, and can correspondingly obtain a user identifier of the requesting user and a card identifier of the first bank card. Then, in step S311, the payment platform can generate a first code string for the user identifier and the card identifier of the first bank card.

The payment platform can generate the first code string by using various algorithms. In an implementation, the payment platform can randomly generate a character string with a predetermined length as the first code string. In another implementation, the payment platform can form a character string by using the user identifier of the user and the card identifier of the first bank card, and then perform a hash operation on the character string, where a result of the hash operation is used as the first code string. In still another implementation, the payment platform can further form a character string by using the user identifier of the user, the card identifier of the first bank card, and a current time, and then perform a hash operation on the character string to obtain the first code string. According to different generation algorithms, a length and a form of the first code string can also be implemented in multiple methods. For example, a numerical string, a letter string, a numerical and letter string, etc. with a preferred length between 4 and 10 digits.

After generating the first code string, in step S312, the payment platform stores the generated first code string in association with the user identifier of the user and the card identifier of the first bank card.

In step S313, the payment platform sends a deduction request to the card issuer of the first bank card. The deduction request is used to request to deduct a first amount from an account of the first bank card, and the first code string is included in the deduction request, so a bill of the first bank card includes the first code string.

In an implementation, the first amount can be an amount corresponding to a minimum payment unit of a local settlement currency, for example, RMB 1 cent. More preferably, the first amount can be an amount corresponding to a minimum payment unit of an international settlement currency, for example, $ 1 cent. Certainly, the first amount may not be fixed, but is randomly generated in a relatively small predetermined range. For example, an amount between one cent and five cents is randomly selected as the first amount.

In different implementations, the deduction request can include the first code string in different fields. In an implementation, the first code string can be included in a trade-related product information field in the deduction request. In another implementation, the deduction request includes a note information field, and the first code string can be filled in the note information field.

For the deduction request, in step S314, the card issuer deducts the first amount from the account corresponding to the first bank card based on an instruction of the deduction request, and generates a bill, where the bill includes the first code string. Specifically, the first code string is included in different positions of the bill based on a field in which the first code string is in the deduction request.

Therefore, the legal card holder can obtain the generated first code string by querying the bill. Then, the user can re-enter the identity verification page to start the verification phase process.

Specifically, in step S320, the user can enter a verification code string into an entry interface reserved on the page based on a page prompt of the identity verification page. For simplicity of description, the code string entered by the user is referred to as a second code string. In other words, in this step, the payment platform receives the second code string entered by the user.

Next, in step S321, the payment platform obtains, based on the user identifier and the card identifier of the first bank card, the first code string that is pre-stored in association with the user identifier and the card identifier, that is, the first code string stored in step S312.

Then, in step S322, the payment platform verifies whether the received second code string is consistent with a stored corresponding part of the first code string, and in step S323, determines, based on a verification result, an identity verification result of the user for the first bank card. Specifically, if the second code string is consistent with the corresponding part of the first code string, it is determined that the user identity verification succeeds; otherwise, the identity verification fails. Then, in step S324, the identity verification result is notified to the user.

Similarly, when the payment request previously sent by the user by using the first bank card is suspended, the payment platform can continue to process the payment request after determining that the user identity is verified, and notify the user of a processing result.

In the implementation of FIG. 3, generation and verification of the verification code and other processing related to payment are performed by the payment platform. As such, multiple interactions with the security platform are not necessary, and efficiency is improved. Correspondingly, compared with the method procedure in FIG. 2, the procedure in the implementation in FIG. 3 omits an interaction step between the payment platform and the security platform. For specific implementations of other steps and details of the implementation, references can be made to the description with reference to FIG. 2. Details are omitted here for simplicity.

In conclusion, based on this implementation of the present specification, the verification code for verifying the payment identity of the user is included in the bank bill, so only a legal card holder can know the verification code by querying the bill, so as to complete identity verification. In the previous process, there is no need for the user to submit a photo or other proof data, and there is no need for manual verification, which saves labor cost and improves payment experience of the user.

An implementation according to another aspect further provides a payment identity verification device.

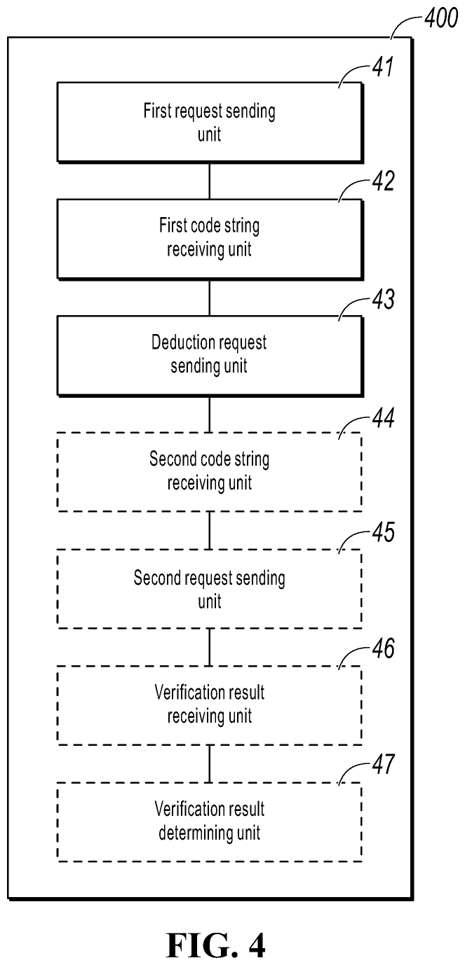

FIG. 4 is a schematic block diagram illustrating a payment identity verification device, according to an implementation. The device is deployed on a payment platform, and the payment platform can be implemented by using any device, platform, or device cluster that has a calculation and processing capability. As shown in FIG. 4, the verification device 400 includes: a first request sending unit 41, configured to send a first request message to a security platform in response to a verification request of a first user, where the verification request is used to request to verify a card owner identity of the first user for a first bank card, and the first request message includes a user identifier of the first user and a card identifier of the first bank card; a first code string receiving unit 42, configured to receive, from the security platform, a first code string generated for the first request message; and a deduction request sending unit 43, configured to send a deduction request to a card issuer of the first bank card, where the deduction request is used to request to deduct a first amount from an account of the first bank card, and the deduction request includes the first code string, where the card issuer includes the first code string in a bill for the first bank card.

In an implementation, the first amount in the deduction request sent by the deduction request sending unit 43 is an amount corresponding to a minimum payment unit of a settlement currency.

In an implementation, the deduction request includes a transaction-related product information field, and the product information field includes the first code string.

In another implementation, the deduction request includes a note information field, and the note information field includes the first code string.

In an implementation, the device further includes (not shown): a payment request receiving unit, configured to receive a first payment request requesting that the first user uses the first bank card to make payment; a first notification unit, configured to send a first notification to the first user indicating that the first payment request is rejected or suspended, where the first notification includes entry information that points to an identity verification page; and a verification request receiving unit, configured to receive the verification request of the first user, where the verification request is sent by the first user by performing a predetermined operation on the identity verification page by using the entry information.

According to an implementation, the device 400 further includes: a second code string receiving unit 44, configured to receive a second code string entered by the first user and used to verify the card owner identity of the first user for the first bank card; a second request sending unit 45, configured to send a second request message to the security platform, where the second request message includes the user identifier of the first user, the card identifier of the first bank card, and the second code string; a verification result receiving unit 46, configured to receive a verification result from the security platform, where the verification result indicates whether the second code string is consistent with a corresponding part of the first code string stored in the security platform; and a verification result determining unit 47, configured to determine an identity verification result of the first user for the first bank card based on the verification result.

Specifically, in an implementation, when the verification result is “consistent”, the verification result determining unit 47 determines that the identity verification result is “succeeded”. The device can further include a second notification unit, configured to send a second notification to the first user indicating that the verification succeeds.

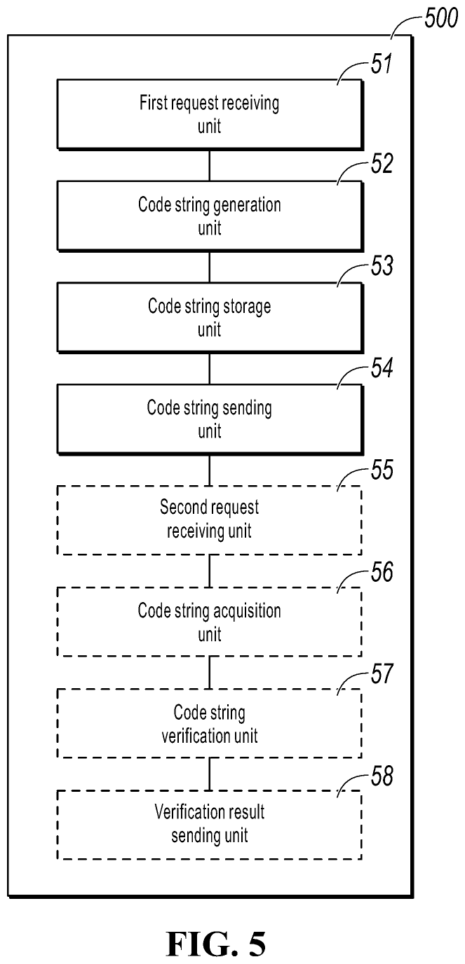

FIG. 5 is a schematic block diagram illustrating a payment identity verification device, according to an implementation. The device is deployed on a security platform, and the security platform can be represented as any device, platform, or device cluster that has a calculation and processing capability. As shown in FIG. 5, the verification device 500 includes: a first request receiving unit 51, configured to receive a first request message from a payment platform, where the first request message includes a user identifier of a first user and a card identifier of a first bank card; a code string generation unit 52, configured to generate a first code string for the first request message; a code string storage unit 53, configured to store the first code string in association with the user identifier of the first user and the card identifier of the first bank card; and a code string sending unit 54, configured to send the first code string to the payment platform, where the payment platform sends a deduction request to a card issuer of the first bank card based on the first code string, where a bill of the first bank card includes the first code string.

In an implementation, the code string generation unit 52 randomly generates a character string with a predetermined length as the first code string.

In another implementation, the code string generation unit 52 forms a first character string by using the user identifier of the first user, the card identifier of the first bank card, and a current time; and performs a hash operation on the first character string to obtain the first code string.

According to an implementation, the device 500 further includes: a second request receiving unit 55, configured to receive a second request message from the payment platform, where the second request message includes the user identifier of the first user, the card identifier of the first bank card, and a second code string entered by the first user; a code string acquisition unit 56, configured to acquire, based on the user identifier of the first user and the card identifier of the first bank card, the first code string stored in association with the user identifier of the first user and the card identifier of the first bank card; a code string verification unit 57, configured to verify whether the second code string is consistent with a corresponding part of the first code string; and a verification result sending unit 58, configured to send a verification result to the payment platform, where the payment platform determines an identity verification result of the first user for the first bank card based on the verification result.

In a specific implementation, the code string verification unit 57 is configured to compare the second code string with a predetermined part of the first code string.

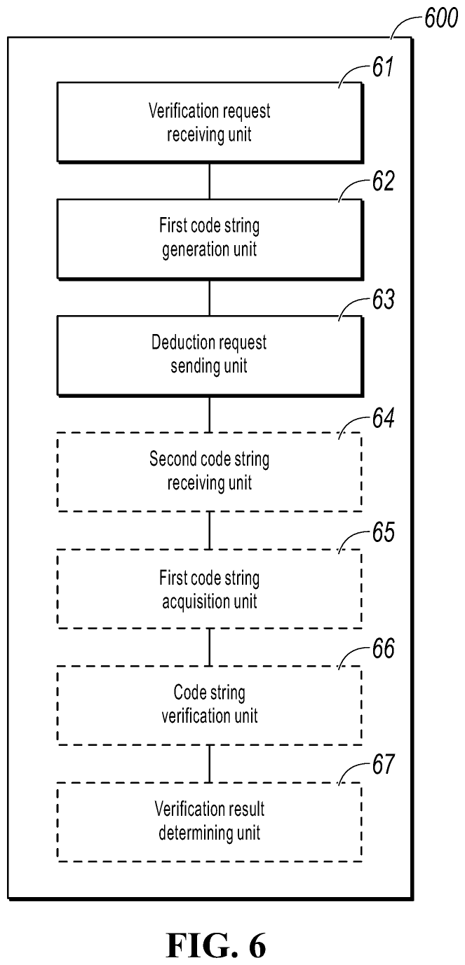

FIG. 6 is a schematic block diagram illustrating a payment identity verification device, according to an implementation. The device is deployed on a payment platform, and the payment platform can be implemented by using any device, platform, or device cluster that has a calculation and processing capability. As shown in FIG. 6, the verification device 600 includes: a verification request receiving unit 61, configured to receive a verification request of a first user, where the verification request is used to request to verify a card owner identity of the first user for a first bank card; a first code string generation unit 62, configured to generate a first code string for a user identifier of the first user and a card identifier of the first bank card, and store the first code string in association with the user identifier of the first user and the card identifier of the first bank card; and a deduction request sending unit 63, configured to send a deduction request to a card issuer of the first bank card, where the deduction request is used to request to deduct a first amount from an account of the first bank card, and the deduction request includes the first code string, where the card issuer includes the first code string in a bill for the first bank card.

According to an implementation, the device 600 further includes: a second code string receiving unit 64, configured to receive a second code string entered by the first user and used to verify the card owner identity of the first user for the first bank card; a first code string acquisition unit 65, configured to acquire, based on the user identifier of the first user and the card identifier of the first bank card, the first code string stored in association with the user identifier of the first user and the card identifier of the first bank card; a code string verification unit 66, configured to verify whether the second code string is consistent with a corresponding part of the first code string; and a verification result determining unit 67, configured to determine an identity verification result of the first user for the first bank card based on the verification result.

Based on the previous methods and devices, the verification code for verifying the payment identity of the user is included in the bank bill, so only a legal card holder can know the verification code by querying the bill, so as to complete identity verification.

According to an implementation of another aspect, a computer readable storage medium on which a computer program is stored is further provided. When the computer program is executed in a computer, the computer is caused to perform the method described with reference to FIG. 2 and FIG. 3.

According to an implementation of still another aspect, a computing device is further provided and includes a memory and a processor. Executable code is stored in the memory, and when executing the executable code, the processor implements the method with reference to FIG. 2 and FIG. 3.

A person skilled in the art understands that in the previous one or more examples, functions described in the present disclosure can be implemented by hardware, software, firmware, or any combination thereof. When the present disclosure is implemented by software, the functions can be stored in a computer readable medium or transmitted as one or more instructions or code in the computer readable medium.

The objectives, technical solutions, and benefits of the present disclosure are further described in detail in the previously described specific implementations. It should be understood that the previously described descriptions are merely specific implementations of the present disclosure, but are not intended to limit the protection scope of the present disclosure. Any modification, equivalent replacement, or improvement made based on the technical solutions of the present disclosure shall fall within the protection scope of the present disclosure.

1. A computer-implemented identity verification method, comprising:
receiving, by a payment platform, a payment request associated with a bank card;
determining, by the payment platform, that the payment request represents a security risk;
based on determining that the payment request represents a security risk, sending, by the payment platform, to a user-device, a first electronic notification, the first electronic notification comprising a first interactive element invocable to direct an application of the user-device to an identity verification page,
wherein the identity verification page comprises a second interactive element invocable to send a verification request to the payment platform;
receiving, by the payment platform, the verification request, comprising a user identifier, a request to verify a user identity associated with the bank card, and a card identifier of the bank card;
generating, by the payment platform, a first code string;
storing, by the payment platform, the first code string in association with the user identifier and with the card identifier of the bank card;
sending, by the payment platform, a deduction request to a card issuer of the bank card, wherein the deduction request comprises a request to deduct a first amount from an account associated with the bank card, and wherein the deduction request comprises the first code string;
receiving, by the payment platform, from the user-device, a second code string;
verifying, by the payment platform, that the second code string is consistent with a corresponding part of the first code string, comprising comparing the second code string to the corresponding part of the first code string; and
based on verifying that the second code string matches the corresponding part of the first code string, verifying, by the payment platform, the user identity associated with the bank card.

2. The computer-implemented method of claim 1, wherein generating the first code string comprises:
forming, by the payment platform, a first character string based on at least one of: the user identifier, the card identifier of the bank card, and a current time; and
performing, by the payment platform, a hash operation on the first character string, and obtaining the first code string as a result of the hash operation.

3. The computer-implemented method of claim 1, wherein the first amount corresponds to a minimum payment unit of a currency.

4. The computer-implemented method of claim 1, wherein the first code string is in a field of the deduction request, such that the first code string is included in a corresponding field of a bill generated by the card issuer.

5. The computer-implemented method of claim 1, further comprising:
prompting, by the payment platform, a user associated with the user identity to enter, as the second code string, a code string in a specific location in a bill received by the user from the card issuer.

6. The computer-implemented method of claim 1, further comprising, subsequent to verifying the user identity associated with the bank card:
sending, by the payment platform, a notification indicating a verification success.

7. The computer-implemented method of claim 1, further comprising, prior to receiving the verification request:
suspending, by the payment platform, the payment request;
and further comprising, subsequent to verifying the user identity associated with the bank card:
processing, by the payment platform, the payment request.

8. A non-transitory, computer-readable medium storing one or more instructions executable by a computer system to perform operations comprising:
receiving, by a payment platform, a payment request associated with a bank card;
determining, by the payment platform, that the payment request represents a security risk;
based on determining that the payment request represents a security risk, sending, by the payment platform, to a user-device, a first electronic notification, the first electronic notification comprising a first interactive element invocable to direct an application of the user-device to an identity verification page,
wherein the identity verification page comprises a second interactive element invocable to send a verification request to the payment platform;
receiving, by the payment platform, the verification request, comprising a user identifier, a request to verify a user identity associated with the bank card, and a card identifier of the bank card;
generating, by the payment platform, a first code string;
storing, by the payment platform, the first code string in association with the user identifier and with the card identifier of the bank card;
sending, by the payment platform, a deduction request to a card issuer of the bank card, wherein the deduction request comprises a request to deduct a first amount from an account associated with the bank card, and wherein the deduction request comprises the first code string;
receiving, by the payment platform, from the user-device, a second code string;
verifying, by the payment platform, that the second code string is consistent with a corresponding part of the first code string, comprising comparing the second code string to the corresponding part of the first code string; and
based on verifying that the second code string matches the corresponding part of the first code string, verifying, by the payment platform, the user identity associated with the bank card.

9. The computer-readable medium of claim 8, wherein generating the first code string comprises:
forming, by the payment platform, a first character string based on at least one of: the user identifier, the card identifier of the bank card, and a current time; and
performing, by the payment platform, a hash operation on the first character string, and obtaining the first code string as a result of the hash operation.

10. The computer-readable medium of claim 8, wherein the first amount corresponds to a minimum payment unit of a currency.

11. The computer-readable medium of claim 8, wherein the first code string is in a field of the deduction request, such that the first code string is included in a corresponding field of a bill generated by the card issuer.

12. The computer-readable medium of claim 8, wherein the operations further comprise:
prompting, by the payment platform, a user associated with the user identity to enter, as the second code string, a code string in a specific location in a bill received by the user from the card issuer.

13. The computer-readable medium of claim 8, wherein the operations further comprise, subsequent to verifying the user identity associated with the bank card:
sending, by the payment platform, a notification indicating a verification success.

14. The computer-readable medium of claim 8, wherein the operations further comprise, prior to receiving the verification request:
suspending, by the payment platform, the payment request;
and further comprising, subsequent to verifying the user identity associated with the bank card:
processing, by the payment platform, the payment request.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, by a payment platform, a payment request associated with a bank card;
determining, by the payment platform, that the payment request represents a security risk;
based on determining that the payment request represents a security risk, sending, by the payment platform, to a user-device, a first electronic notification, the first electronic notification comprising a first interactive element invocable to direct an application of the user-device to an identity verification page,
wherein the identity verification page comprises a second interactive element invocable to send a verification request to the payment platform;
receiving, by the payment platform, the verification request, comprising a user identifier, a request to verify a user identity associated with the bank card, and a card identifier of the bank card;
generating, by the payment platform, a first code string;
storing, by the payment platform, the first code string in association with the user identifier and with the card identifier of the bank card;
sending, by the payment platform, a deduction request to a card issuer of the bank card, wherein the deduction request comprises a request to deduct a first amount from an account associated with the bank card, and wherein the deduction request comprises the first code string;
receiving, by the payment platform, from the user-device, a second code string;
verifying, by the payment platform, that the second code string is consistent with a corresponding part of the first code string, comprising comparing the second code string to the corresponding part of the first code string; and
based on verifying that the second code string matches the corresponding part of the first code string, verifying, by the payment platform, the user identity associated with the bank card.

16. The computer-implemented system of claim 15, wherein generating the first code string comprises:
forming, by the payment platform, a first character string based on at least one of: the user identifier, the card identifier of the bank card, and a current time; and
performing, by the payment platform, a hash operation on the first character string, and obtaining the first code string as a result of the hash operation.

17. The computer-implemented system of claim 15, wherein the first amount corresponds to a minimum payment unit of a currency.

18. The computer-implemented system of claim 15, wherein the first code string is in a field of the deduction request, such that the first code string is included in a corresponding field of a bill generated by the card issuer.

19. The computer-implemented system of claim 15, wherein the operations further comprise:
prompting, by the payment platform, a user associated with the user identity to enter, as the second code string, a code string in a specific location in a bill received by the user from the card issuer.

20. The computer-implemented system of claim 15, wherein the operations further comprise, prior to receiving the verification request:
suspending, by the payment platform, the payment request;
and further comprising, subsequent to verifying the user identity associated with the bank card:
processing, by the payment platform, the payment request.
